(19) United States
(12) Patent Application Publication
(10) Pub. No.: US 2024/0354861 A1
(43) Pub. Date: Oct. 24, 2024

(54) SYSTEMS AND METHODS FOR ASSIGNING INSURANCE PREMIUM DISCOUNTS ASSOCIATED WITH VEHICLE SAFETY FEATURES

(71) Applicant: StickerLookup Inc., Alpharetta, GA (US)

(72) Inventor: Suchita Dhawan, Alpharetta, GA (US)

(73) Assignee: StickerLookup Inc., Alpharetta, GA (US)

(21) Appl. No.: 18/685,801

(22) PCT Filed: Oct. 17, 2022
(86) PCT No.: PCT/US22/46908

§ 371 Date: Feb. 22, 2024

Related U.S. Application Data
(60) Provisional application No. 63/262,575, filed on Oct. 15, 2021.

(51) Int. Cl. G06Q 40/08; G06Q 30/0201; G06Q 30/0207; G06V 30/40

(52) U.S. Cl. CPC G06Q 40/08; G06Q 30/0206; G06Q 30/0222; G06V 30/40

(57) ABSTRACT

A system and a method are provided that acquire a vehicle's safety features and use them as part of the risk assessment criteria when determining insurance premiums. The system and method can capture all the vehicle's safety features outlined on the Monroney label at the point of sale (POS) and process them as part of the risk assessment criteria in determining an insurance premium discount for the vehicle. The entire process is automated from the time that a consumer uploads an image of the Monroney label at the POS to the time that one or more premium discount percentage quotes from one or more insurance providers are presented to the consumer to allow the consumer to purchase the insurance policy at the discounted price.

### CROSS REFERENCE TO RELATED APPLICATIONS

The present application is a U.S. nonprovisional patent application claiming priority to and the benefit of the filing date of U.S. provisional patent application Ser. No. 63/262,575, filed on Oct. 15, 2021, entitled “SYSTEMS AND METHODS FOR ASSIGNING INSURANCE PREMIUM DISCOUNTS ASSOCIATED WITH VEHICLE SAFETY FEATURES,” which is incorporated by reference herein in its entirety.

### TECHNICAL FIELD

Exemplary embodiment(s) of the present disclosure relates generally to vehicle insurance premium discounts and, more specifically, to systems and methods for collecting and processing vehicle safety features to determine risk and offer insurance premium discounts based on those risk via a marketplace platform.

### BACKGROUND OF THE DISCLOSURE

Vehicle or automobile insurance is mandated by most states and provides financial protection in the event of an accident or theft. Typically, the driver will enter into a contract with an insurance provider to provide coverage which will protect them against financial loss in the event of accident or theft. In exchange for the insurance coverage, the customer will pay an amount to the company on a regular basis, often every month or every six months. These payments from the customer, who then becomes the insured, are often referred to as “premiums.”

Every insurance company determines rates differently, but the premium is typically based on details about the insured. Insurance providers generally seek to determine insurance policy premiums for a vehicle based mostly on the risk of losses associated with the driver or intended insured(s). This determination often takes into account various attributes of the driver that will influence the probability of loss under the policy. Premiums may typically be determined by the driver's age, driving history, credit score, years of driving experience, and demographic factors.

In the last few years, automobile technology has advanced at a rapid rate. Most modern vehicles are equipped with artificial intelligence, alerts, and other advanced safety features that reduce the risk of loss during the insured's policy term. Known premium determination methods do not, however, include these advanced safety features as part of the risk assessment criteria when determining the premium.

### BRIEF DESCRIPTION OF THE SEVERAL VIEWS OF THE DRAWING

The example embodiments are best understood from the following detailed description when read with the accompanying drawing figures. It is emphasized that the various features are not necessarily drawn to scale. In fact, the dimensions may be arbitrarily increased or decreased for clarity of discussion. Wherever applicable and practical, like reference numerals refer to like elements.

FIG. 1 is a block diagram showing the marketplace platform architecture with a portable computing device (PCD) of a user communicating with the system of the present disclosure via a network in accordance with a representative, or exemplary, embodiment.

FIG. 2 is a screenshot of a page that the processor shown in FIG. 1 causes to be displayed to the person acting as the marketplace platform administrator for an insurance company when the administrator is setting up the account for the marketplace platform in accordance with a representative, or exemplary, embodiment.

FIG. 3 shows a screenshot of a page that the processor shown in FIG. 1 causes to be displayed to the administrator of the marketplace platform of a vehicle dealer that allows the administrator to select which insurance companies the dealer will use for the premium discounts in accordance with a representative, or exemplary, embodiment.

FIG. 4 shows a screenshot of a page that the processor shown in FIG. 1 causes to be displayed to the administrator of the marketplace platform of a vehicle dealer that allows the administrator to select which premium discount percentage quotes and how many premium discount percentage quotes will be sent to the PCD of the user in accordance with a representative, or exemplary, embodiment.

FIG. 5 shows a screenshot of a page that the processor shown in FIG. 1 causes to be displayed to the user prompting the user to upload the window sticker and enter some basic information about the user and the vehicle of interest in accordance with a representative, or exemplary, embodiment.

FIG. 6 shows a screenshot of a page that the processor shown in FIG. 1 causes to be displayed to the user after the user has filled in the page shown in FIG. 5, uploaded the window sticker and selected the Submit Details button in the page shown in FIG. 5 in accordance with a representative, or exemplary, embodiment.

FIG. 7 shows an example of a page that the processor shown in FIG. 1 causes to be displayed on the PCD of the user when the user enters the requested information in the page shown in FIG. 6 and clicks the Submit Your Info button in this page in accordance with a representative, or exemplary, embodiment.

FIG. 8 shows an example of a page that the processor shown in FIG. 1 causes to be displayed on a display device of a remote computing device (not shown) being used by an agent of an insurance company to allow an agent or other employee of the insurance company to log into the system shown in FIG. 1, review enquiries that have been made by users for premium discount percentage quotes, select any of the enquiries to review details about the enquiry such as personal information about the user who made the enquiry, information about the vehicle associated with the enquiry, etc., review the preliminary quote that was made to the user and then enter a final premium discount percentage to be offered to the user.

FIG. 9 is a flow diagram illustrating the method performed by the user using the PCD shown in FIG. 1 or some other computing device in accordance with a representative embodiment.

FIG. 10 is a flow diagram representing the method performed by the system shown in FIG. 1 in accordance with a representative embodiment.

### DETAILED DESCRIPTION OF THE DISCLOSURE

As indicated above, known premium determination methods do not include the aforementioned advanced safety features as part of the risk assessment criteria used when determining insurance premiums. Incorporating such safety features into the premium assessment process can be financially beneficial to the insured who purchases a vehicle with high quality safety equipment and can assist the insurance industry in more accurately and adequately assessing the risk and probability of loss.

The present disclosure discloses a system and a method that acquire the vehicle's advanced safety features and use them as part of the risk assessment criteria when determining insurance premiums. In accordance with a representative, or exemplary, embodiment, the system and a method of the present disclosure capture all the vehicle's advanced safety features outlined on the Monroney label at the point of sale (POS) and process them as part of the risk assessment criteria in determining an insurance premium discount for the vehicle. Moreover, in accordance with a preferred embodiment, the entire process is automated from the time that a consumer uploads an image of the Monroney label at the POS to the time that one or more premium discount percentage quotes from one or more insurance providers are presented to the consumer and the consumer is allowed to purchase the insurance policy. The consumer is given the option of selecting one of the presented premium discount percentage quotes and execute a payment method to become insured.

In the following detailed description, for purposes of explanation and not limitation, exemplary, or representative, embodiments disclosing specific details are set forth in order to provide a thorough understanding of the inventive principles and concepts. However, it will be apparent to one of ordinary skill in the art having the benefit of the present disclosure that other embodiments according to the present teachings that are not explicitly described or shown herein are within the scope of the appended claims. Moreover, descriptions of well-known apparatuses and methods may be omitted so as not to obscure the description of the exemplary embodiments. Such methods and apparatuses are clearly within the scope of the present teachings, as will be understood by those of skill in the art. It should also be understood that the word “example,” as used herein, is intended to be non-exclusionary and non-limiting in nature.

The terminology used herein is for purposes of describing particular embodiments only and is not intended to be limiting. Any specifically-defined terms are in addition to the technical, scientific, or ordinary meanings of the defined terms as commonly understood and accepted in the relevant context.

The terms “a,” “an” and “the” include both singular and plural referents, unless the context clearly dictates otherwise. Thus, for example, “a device” includes one device and plural devices. The terms “substantial” or “substantially” mean to within acceptable limits or degrees acceptable to those of skill in the art. For example, the term “substantially parallel to” means that a structure or device may not be made perfectly parallel to some other structure or device due to tolerances or imperfections in the process by which the structures or devices are made. The term “approximately” means to within an acceptable limit or amount to one of ordinary skill in the art.

Relative terms, such as “over,” “above,” “below,” “top,” “bottom,” “front,” “back,” “upper” and “lower” may be used to describe the various elements' relationships to one another, as illustrated in the accompanying drawings. These relative terms are intended to encompass different orientations of the device and/or elements in addition to the orientation depicted in the drawings. For example, if the device were inverted with respect to the view in the drawings, an element described as “above” another element, for example, would now be below that element.

It will be understood that when an element is referred to as being “connected to” or “coupled to” or “electrically coupled to” another element, it can be directly connected or coupled, or intervening elements may be present.

The term “memory” or “memory device”, as those terms are used herein, are intended to denote a non-transitory computer-readable storage medium that is capable of storing computer instructions, or computer code, for execution by one or more processors. References herein to “memory” or “memory device” should be interpreted as one or more memories or more memory devices. The memory may, for example, be multiple memories within the same computer system. The memory may also be multiple memories distributed amongst multiple computer systems or computing devices.

A “processor”, as that term is used herein encompasses an electronic component that is able to execute a computer program or executable computer instructions. References herein to a computer comprising “a processor” should be interpreted as one or more processors or processing cores. The processor may for instance be a multi-core processor. A processor may also refer to a collection of processors within a single computer system or distributed amongst multiple computer systems. The term “computer” should also be interpreted as possibly referring to a collection or network of computers or computing devices, each comprising a processor or processors. Instructions of a computer program can be performed by multiple processors that may be within the same computer or that may be distributed across multiple computers.

A “computing device,” as that term is used herein, may include multiple subsystems, cores or other components. Such a computing device may be, for example, a portable computing device (“PCD”), such as a mobile phone, a tablet portable computer (e.g., an iPad), a laptop computer, a smart wearable device, and Internet of Things (IoT) device, a smartphone, or a portable digital assistant (PDA) having a wireless modem for communicating over a wireless communications network.

The term “user,” as that term is used herein, may include a vehicle driver, a prospective vehicle customer shopping for a vehicle, or an existing vehicle owner.

The term “vehicle,” as that term is used herein, may include a car, a truck, a motorcycle, a van or a thing used for transporting people or goods, especially on land.

In general, the present disclosure discloses a system and method for collecting and processing vehicle safety features to determine risk and to offer insurance premium discounts to consumers based on the determined risk via a marketplace platform. The system comprises an architecture that typically includes both hardware and software that enable users, vehicle dealers and insurance companies to participate in the marketplace platform.

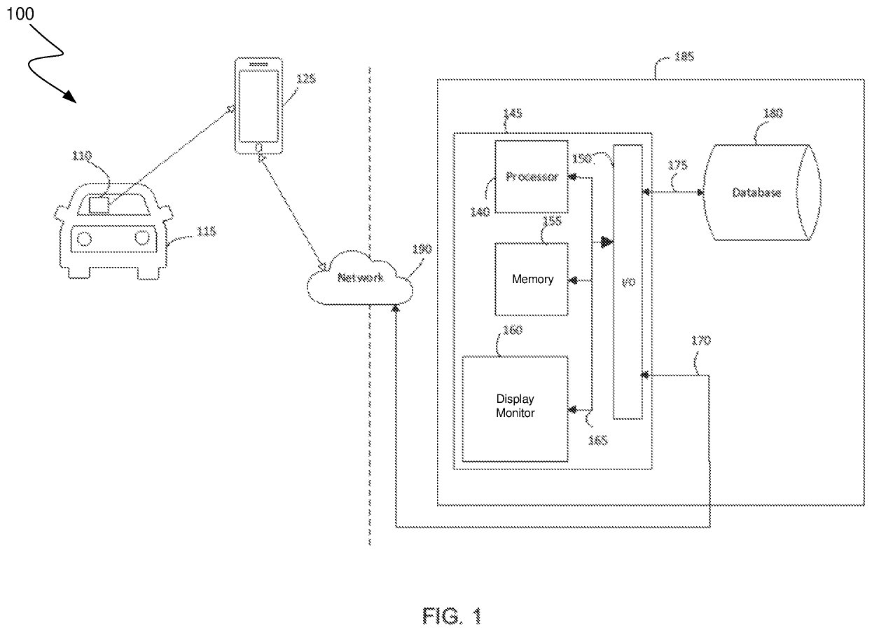

FIG. 1 is a block diagram showing the marketplace platform architecture with a PCD 125 of a user communicating with the system 185 via a network 190. The system 185 has been configured based on preferences or settings that have been set by vehicle dealers and insurance companies that are participating in the marketplace platform. The marketplace platform may comprise multiple instances of the system 185 shown in FIG. 1 to allow the system 185 to be scaled out for simultaneous use by many users, dealers and insurance companies via the network 190, which can be the Internet and/or a combination of wireless and/or wired networks. For ease of illustration, a single instance of the system 185 is shown in FIG. 1. As will be appreciated by those of skill in the art, the system 185 can be implemented by multiple servers, databases, gateways, and firewalls. In the representative embodiment shown, the system 185 typically comprises a processor 140, an input/output (I/O) interface 150, a local memory device 155 and a display monitor. The system 185 is in communication with the network 190 and with one or more external databases 170 via one or more wired or wireless links.

An exemplary embodiment will now be described for a scenario in which a user is present at a vehicle dealer to purchase a vehicle and the dealer is a participant in the marketplace of the present disclosure. Dealers and insurance companies that want to participate in the marketplace can use a remote computing device such as a desktop computer or laptop computer to create and manage accounts in the system 185. Administrators of the marketplace platform for the dealers with profiles use the remote computing device to create profiles and set settings and preferences that are stored in memory device 155. When performing the method of the present disclosure, the processor 140 will receive a request for a premium discount percentage quote from the PCD 125 and will process the corresponding profiles, settings and preferences stored in the memory device 155 to generate insurance premium discount percentage quotes, which are then communicated to the user's PCD 125. When a given dealer sets up an account in the system 185, the dealer can enter a list of insurance companies from which customers of the dealer can receive premium discount quotes. When insurance companies set accounts in the system 185, they can set up lists of safety features for which they will give premium discounts as well as lists of discount percentages that will be given for each of these security features. These lists associated with the dealers and insurance companies will also be stored in memory 155 or in some other memory device that is accessible by the processor 140, such as in database 180.

In this example, an employee of the vehicle dealer, such as a sales person for the dealership, presents a QR code to the user of PCD 125. When the user scans in the QR code, the processor 140 causes a page to be opened on a display device of the PCD 125. The page contains instructions and data entry fields instructing the user to enter certain information about the user and also instructing the user to upload an image of the window sticker 110, also referred to herein as the Monroney label, on the vehicle 115 that the user is interested in purchasing. When the user submits the requested user information and uploads the window sticker image, the processor 140 performs an algorithm that parses the uploaded data, which includes the vehicle identification number (VIN). The processor 140 then uses some or all of this data to access one or more external databases, such as database 180, to retrieve a list of safety features that the vehicle 115 includes.

After retrieving the safety feature list, the processor 140 converts the safety features into a standardized format, as different vehicle manufacturers sometimes use different names for the same safety feature. After generating the standardized safety feature list, the processor 140 performs an algorithm that generates a vehicle IQ (VIQ) score based on the standardized list of safety features. This VIQ score will be used subsequently to obtain insurance premium discount percentages offered by one or more insurance companies and present them to the user on the PCD 125.

When the insurance companies set up their accounts in the system 185, each insurance company includes at least one range of acceptable VIQ scores in its preference settings. Each insurance company also sets premium discount percentage settings it is willing to give for each type of safety feature. The processor 140 determines whether VIQ score of the vehicle 115 is within any of the VIQ score ranges that have been set by the insurance companies that are associated with the dealer. If so, the processor 140 calculates, for each insurance company having a VIQ score range that the VIQ score fell into, the total discount percentage associated with the standardized list of safety features for the vehicle 115. The processor 140 then forwards one or more of the names of the insurance companies along with the corresponding premium discount percentage quotes to the PCD 125. When the dealer sets up the account with the system 185, the dealer is given the option of choosing a maximum number of discount percentage quotes that are to be sent to the PCD 125, such as the top three premium discount percentage quotes from three of the listed insurance companies, for example. Based on these dealer settings, the processor 140 causes the quotes to be displayed on the PCD 125.

It should be noted that this first premium discount percentage quote is a preliminary quote that does not constitute a legal offer. When the processor 140 sends the preliminary quotes to the PCD 125, they include a link that the user can select if the user is interested in receiving a detailed quote corresponding to a legally-binding offer from the insurance policy. If the user selects this link, the processor 140 will cause a page to be opened that will request certain user personal information of the type that is usually obtained by insurance companies from people seeking coverage, such as age, the planned use of the vehicle, the residence address of the user, driving record information or authorization to check the user's driving record, the primary purpose for which the vehicle 115 will be used, etc. When the user enters this information, the processor 140 processes the new information and may revise the premium discount percentage based on the new information. Alternatively, the processor 140 can send this information to the insurance company, which can then decide whether to revise the premium discount percentage that was quoted to the user. The processor 140 then causes a final premium discount percentage quote to be sent to the PCD 125 and displayed on the PCD 125 along with a link that the user can select to make payment of the premium.

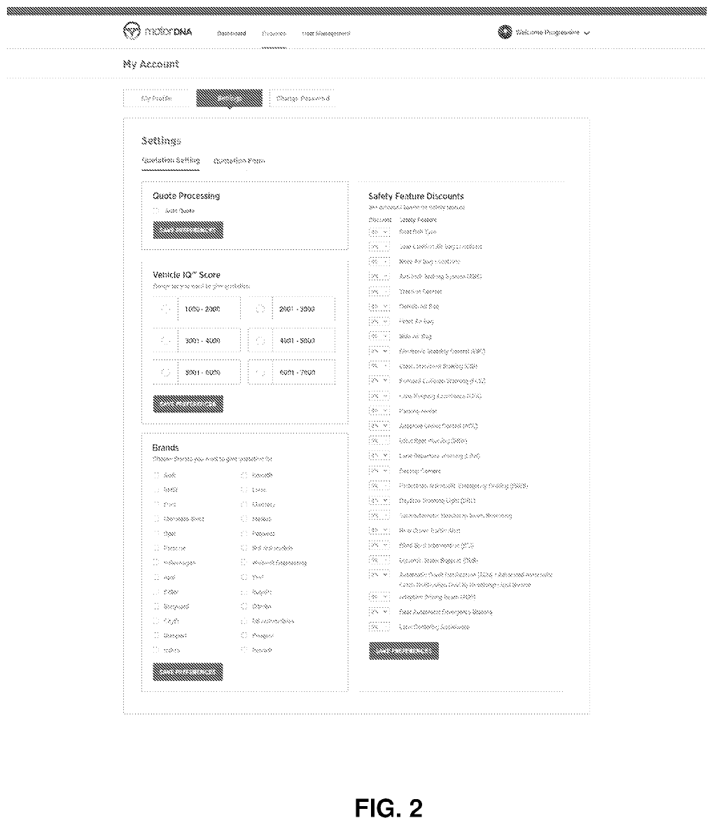

FIG. 2 is a screenshot of a page that the processor 140 causes to be displayed to the person acting as the marketplace platform administrator for an insurance company when the administrator is setting up the account for the marketplace platform. The processor 140 executes a software program that generates the page and processes the data entered into the fields of the page corresponding to settings and preferences to be used for the company's account. In FIG. 2, it can be that the administrator can select different ranges of VIQ scores for which the company will give users premium discounts. This page also shows a list of the standardized safety features and allows the administrator to use drop down menus to set specific premium discount percentages for each of the listed safety features. This page also allows the administrator to select vehicle brands for which the insurance company will give discounts percentages.

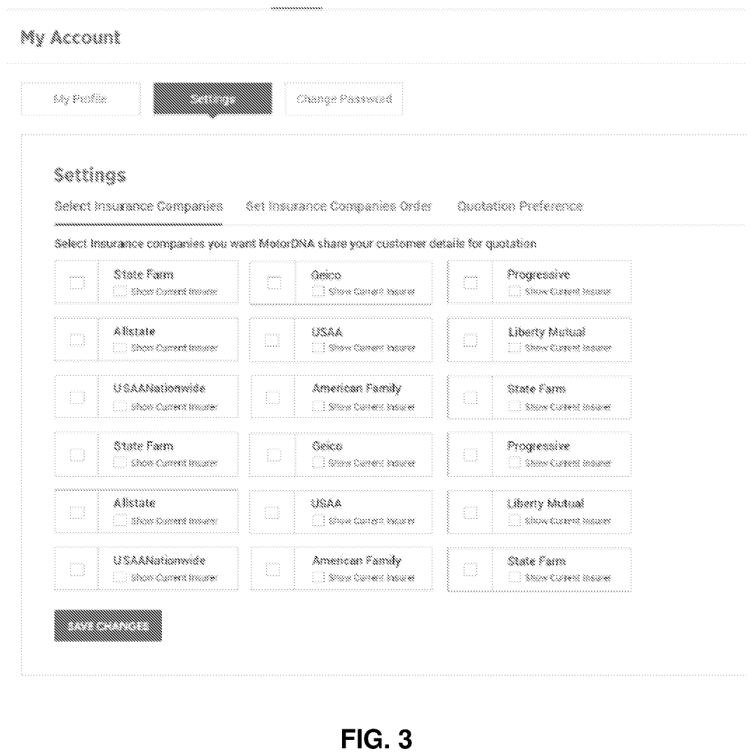

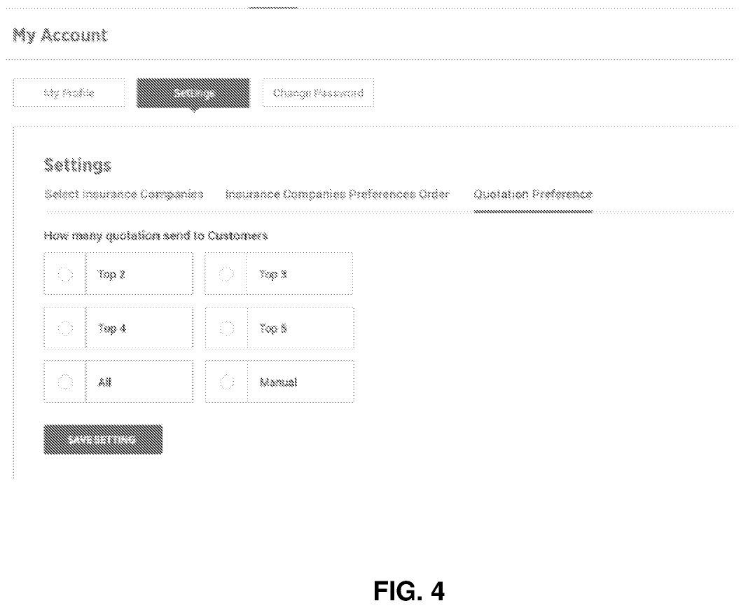

When the user uploads the window sticker and the other information discussed above, the processor 140 executes a software computer program that performs the tasks discussed above of calculating the VIQ score for the given safety features, determining whether the VIQ score is within any of the VIQ score ranges that have been set by the insurance companies using the page shown in FIG. 2, and if so, calculating the total discount percentage based on the percentages that have been set in the page shown in FIG. 2. The total discount percentages, the names of the corresponding insurance companies and the VIQ score to the PCD 125. As indicated above, when the dealer sets up the account with the system 185, the dealer is given the option of choosing a maximum number of discount percentage quotes that are to be sent to the PCD 125, such as the top three premium discount percentage quotes from three of the listed insurance companies. FIGS. 3 and 4 show screenshots of pages that are displayed to the administrator of the marketplace platform of one of the dealers. The page shown in FIG. 3 allows the administrator to select which insurance companies the dealer will use for the premium discounts while the page shown in FIG. 4 allows the administrator to select which premium discount percentage quotes and how many premium discount percentage quotes will be sent to the PCD 125. These selections are stored by the processor 140 in memory device 155 and used by the processor 140 in the manner described above. The administrator can log into the system and cause the processor 140 to run this software program at any time to manage these settings or preferences.

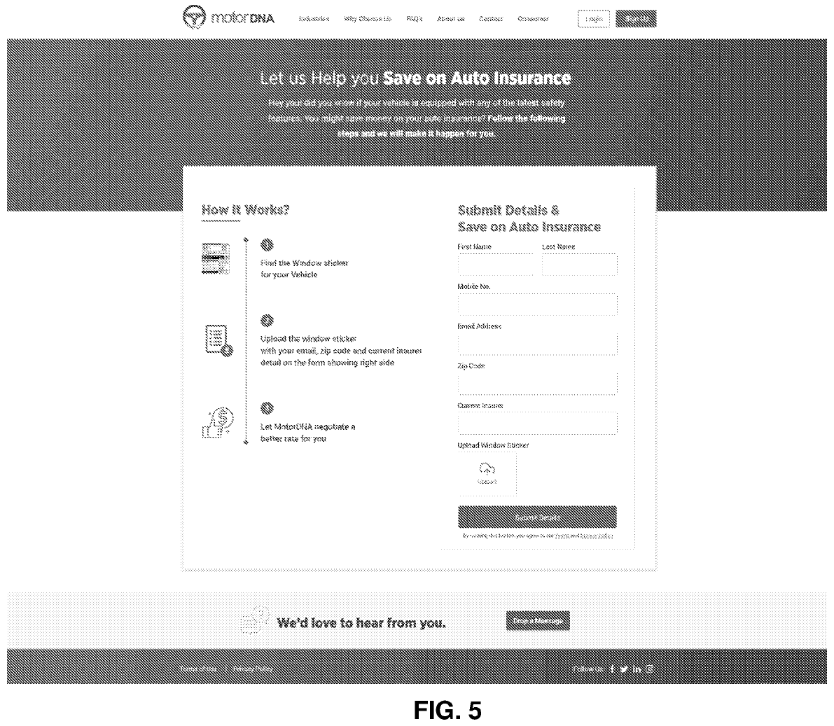

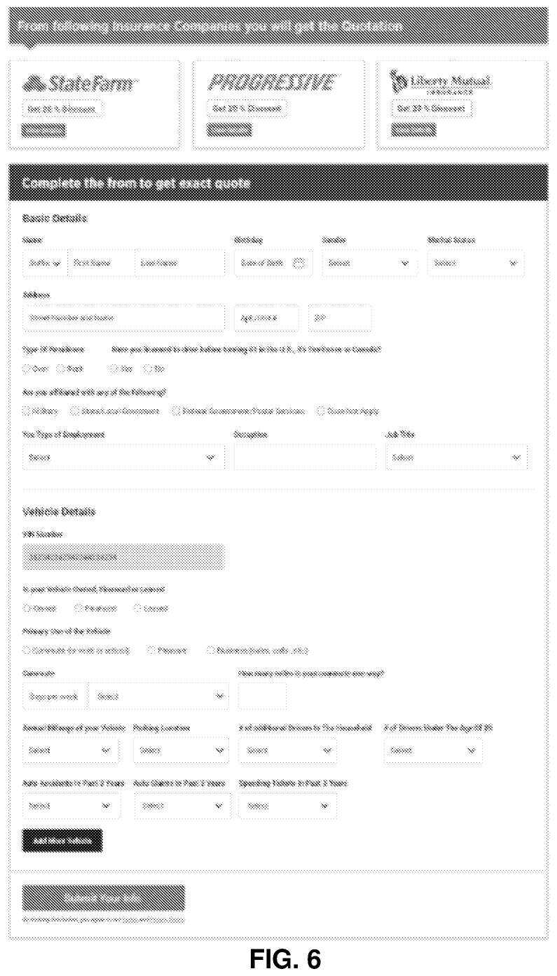

As indicated above, the premium discount percentage quotes that the processor causes to be sent to the user after the user uploads the window sticker and enters some basic information about the user are not legally-binding quotes. FIG. 5 shows a screenshot of a page that the processor 140 causes to be displayed to the user prompting the user to upload the window sticker and enter some basic information about the user and the vehicle of interest. FIG. 6 shows a screenshot of a page that the processor 140 causes to be displayed to the user after the user has filled in the page shown in FIG. 5, uploaded the window sticker and selected the Submit Details button in the page shown in FIG. 5. In this example, the page shown in FIG. 6 contains three premium discount percentage quotes from three different insurance companies of 20% each, but these are not legally binding offers. The page shown in FIG. 6 prompts the user to enter more detailed information about the user that the insurance companies use to determine whether or not the quoted premium discount percentages need to be adjusted based on the information entered in this page. If the user enters the requested additional information and clicks the Submit Your Info button in this page, the processor 140 can either automatically calculate the final quotes based on settings and preferences that were previously entered by the administrators of the marketplace platforms for those insurance companies or an agent at those companies can manually review the new information and cause the final quote to be sent to the system 185, which will then cause the final quote to be delivered to the PCD 125.

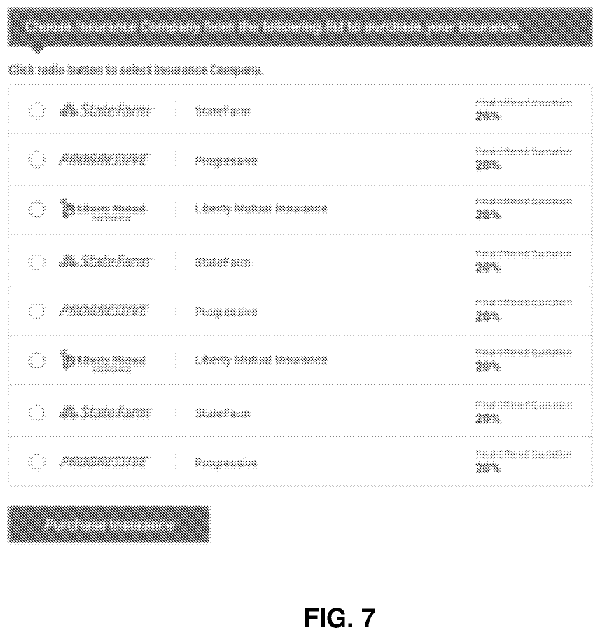

FIG. 7 shows an example of a page that the processor 140 causes to be displayed on the PCD 125 when the user enters the requested information in the page shown in FIG. 6 and clicks the Submit Your Info button in this page. This page shows the final discount premium percentages being offered by multiple insurance companies. The user can select one of the offers and then select the Purchase Insurance button to cause another page to be displayed on the PCD 125 that the user can interact with to make payment.

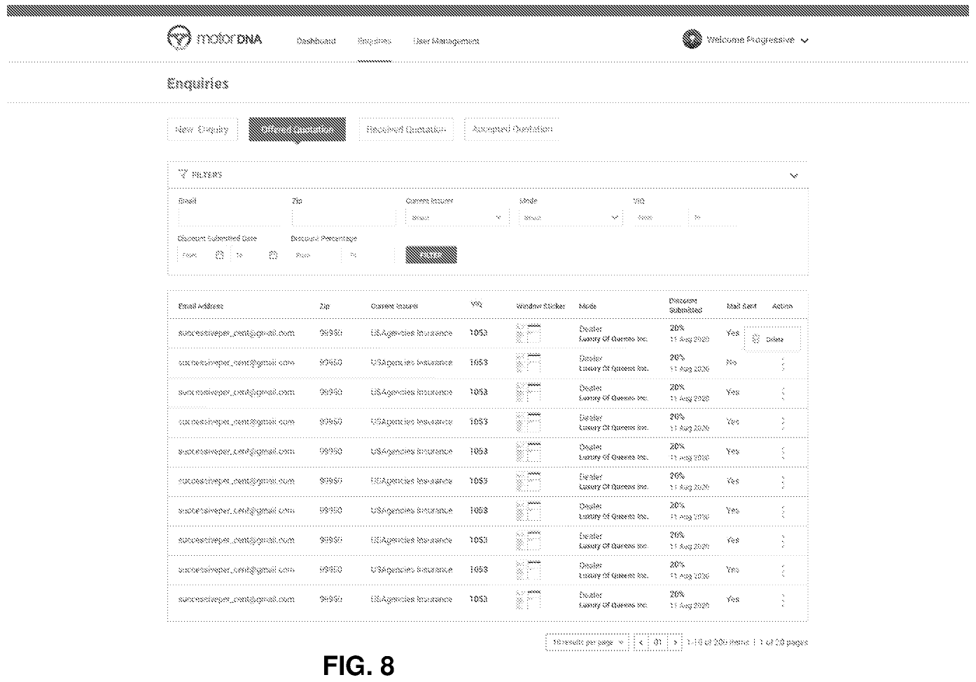

FIG. 8 shows an example of a page that the processor 140 causes to be displayed on a display device of a remote computing device (not shown) being used by an agent of one of the insurance companies. This page shows premium discount percentage enquiries that have been made by users of the marketplace platform, either from their PCDs or from other computing devices. This page allows an agent or other employee of the insurance company to log into the system 185, review enquiries that have been made by users for premium discount percentage quotes, select any of the enquiries to review details about the enquiry such as personal information about the user who made the enquiry, information about the vehicle associated with the enquiry, etc., review the preliminary quote that was made to the user and then enter a final premium discount percentage to be offered to the user. This page also allows the agent or other employee to determine whether a final premium discount percentage quote has already been offered to the user and whether the offer was accepted by the user.

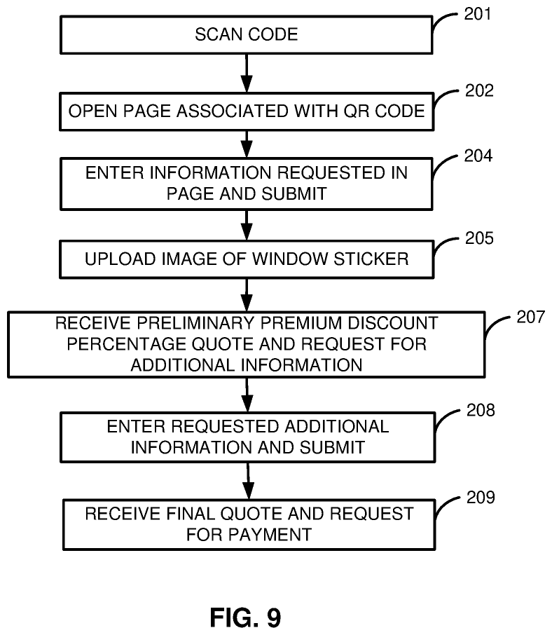

FIG. 9 is a flow diagram illustrating the method performed by the user using the PCD 125 or some other computing device in accordance with a representative embodiment. As indicated above, an employee of the vehicle dealer, such as a sales person for the dealership, presents a QR code to the user of PCD 125. When the user scans in the code (e.g., a bar code, QR code or other code), as indicated by block 201, the processor 140 causes a page to be opened on a display device of the user's computing device, as indicated by block 202. The page contains instructions and data entry fields instructing the user to enter certain information about the user and also instructing the user to upload an image of the window sticker of the vehicle 115 that the user is interested in purchasing. When the user submits the requested user information and uploads the window sticker image, as indicated by blocks 204 and 205, the processor 140 performs an algorithm that parses the uploaded data and then uses some or all of this data to access one or more external databases to retrieve a list of safety features that the vehicle includes. The processor 140 converts the safety features into a standardized format then performs the algorithm that generates the VIQ score based on the standardized list of safety features, uses this VIQ score to obtain insurance premium discount percentages offered by one or more insurance companies and sends them to the user's computing device.

The user's computing device receives these preliminary premium discount percentage quote(s) along with request to enter additional user information in order to receive a detailed premium discount percentage, i.e., a legally-binding premium discount percentage quote, as indicated by block 207. Assuming the user enters the additional requested information, as indicated by block 208, the processor 140 obtains the final premium discount percentage quote and causes it to be sent to the user's computing device, as indicated by block 209.

It should be noted that many variations can be made to the method represented by the flow diagram shown in FIG. 9. For example, in cases where the user is considering purchasing a vehicle from an individual rather than a dealer, there may not be a window sticker, in which case the step represented by blocks 201 and 205 can be eliminated. In such cases, block 202 corresponds to the user accessing the page shown in FIG. 5 or a similar page that does not require that a window sticker be uploaded from a website for the marketplace platform. The user enters the requested information and the safety features are obtained by the processor 140 using the VIN and/or the make, model and year of the vehicle to access the safety features. The steps represented by blocks 204 and 207-209 can remain unchanged.

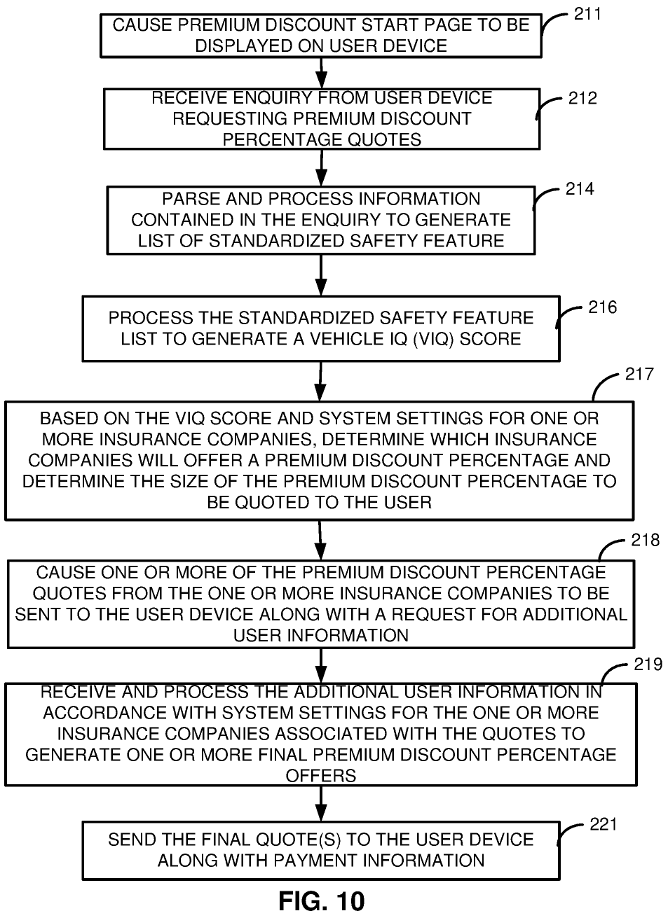

FIG. 10 is a flow diagram representing the method performed by the system 185 shown in FIG. 1 in accordance with a representative embodiment. As indicated above, when the user scans in the QR code or accesses a page on a website for the marketplace platform, the premium discount percentage start page shown in FIG. 5 is displayed on the user's computing device, as indicated by block 211. When the user enters the information requested in this page and uploads the window sticker, the processor 140 receives this information, parses and processes it to generate a list of safety features that the vehicle of interest has, as indicated by block 214. The processor 140 then converts the list of safety features into a standardized list of safety features and uses the converted safety features to calculate the VIQ score for the vehicle, as indicated by block 216. The processor 140 processes the VIQ score based on the settings and preferences that were previously set in the page shown in FIGS. 2 and 4 to determine discount percentage quotes to be sent to the user's computing device, as indicated by block 217. Those quotes are then sent to the user's computing device along with request for additional user information if the user desires to obtain the more detailed, i.e., legally binding quote, as indicated by block 218. Assuming the user enters this additional information, the processor 140 processes this information in accordance with the settings and preferences previously set by the insurance companies, as indicated by block 219, and causes the final premium discount percentage quote(s) to be sent to the user's computing device along with information on how to purchase the policy, as indicated by block 221.

As indicated above, the process represented by block 221 can be entirely automated or it can be partially automated and partially manual, depending on preferences of the insurance companies. The user information processed at block 219 can be processed based on settings or preferences previously set by the marketplace platform administrator for the insurance company such that the final quote is entirely automatically generated and sent to the user. Alternatively, some insurance companies may prefer to review and/or verify the information to determine how large or small the final discount percentage should be. In the latter case, an agent or employee of the insurance company can interact with the page shown in FIG. 8 to manually set the final premium discount percentage, which the processor 140 will then cause to be communicated to the user's computing device.

In some embodiments, after-market vehicle safety data (not contained on the Monroney label) may be selectively communicated to and from the PCD 125 or other portable computing device to allow the vehicle owner the option of providing data to the marketplace platform. Such data may be shown to insurance companies or may be hidden the same so that the user can determine whether it's worth installing an after-market safety feature before notifying the insurance company. If the after-market safety feature is passed to insurance company, the insurance can more accurately assess the safety features or other parameters relating to insurance coverage. Such data may be anonymously provided to a central source, where it may be analyzed using criteria as set forth by various insurance companies, allowing an accurate assessment of premiums which may be available for various insurance policies. As the analysis is based upon non-driving conditions and non-operator characteristics, the vehicle owner may facilitate controlling insurance costs, and such information may also be used for actual purposes to provide valuable resources for evaluating characteristics of insurance coverage.

In a non-limiting exemplary embodiment, if the vehicle owner does not have a computer or other access to electronic mail or the like, the marketplace platform may allow a user to communicate via a telephone, using an interactive voice recognition system (IVR) or the like. An IVR system will allow a user to use a touch-tone keypad as an input device for providing or receiving information to the marketplace platform.

The computer code comprising the software and/or firmware that is executed by the processor 140 can be stored in any suitable memory device, such as in memory device 155 shown in FIG. 1. It is understood that there may be other applications that are stored in the memory 155 and are executable by the processor 140. As indicated above, although a single instance of the system 185 is shown in FIG. 1, multiple instances of the system 185 may be employed, such is in a cloud-based system. Also, while the system 185 shows a single instance of the processor 140 and memory device 155, each system 185 may employ multiple instances of the processor 140 and of the memory device 155.

Where any component discussed herein is implemented in the form of software, any one of a number of programming languages may be employed. The term “executable,” as that term is used herein, means a program file that is in a form that can ultimately be run by a suitable processor, such as the processor(s) 140 shown in FIG. 1. Examples of executable programs may be, for example, a compiled program that can be translated into machine code in a format that can be loaded into a random access portion of the memory device 155 and run by the processor(s) 140, source code that may be expressed in proper format such as object code that is capable of being loaded into a random access portion of the memory device 155 and executed by the processor 140, or source code that may be interpreted by another executable program to generate instructions in a random access portion of the memory device 155 to be executed by the processor(s) 140, etc. An executable program may be stored in any portion or component of the memory device 155 including, for example, random access memory (RAM), read-only memory (ROM), hard drive, solid-state drive (SSD), USB flash drive, memory card, optical disc such as compact disc (CD) or digital versatile disc (DVD), floppy disk, magnetic tape, or other memory components, static random access memory (SRAM), dynamic random access memory (DRAM), or magnetic random access memory (MRAM) and other such devices. The ROM may comprise, for example, a programmable read-only memory (PROM), an erasable programmable read-only memory (EPROM), an electrically erasable programmable read-only memory (EEPROM), or other like memory device.

In various embodiments, the processor(s) 140 can be embodied as a collection of discrete, integrated, or a mixture of discrete and integrated analog, digital, or mixed analog and digital hardware circuit components. For example, the processor(s) 140 can be embodied as collections of discrete analog, digital, or mixed analog and digital hardware circuit components. The hardware can include one or more discrete logic circuits, microprocessors, microcontrollers, or DSPs, application specific integrated circuits (ASICs), programmable logic devices (e.g., field-programmable gate array (FPGAs), or complex programmable logic devices (CPLDs)), among other types of processing circuitry.

Is should be noted that many modifications can be made to the example embodiments disclosed herein that are within the scope of the present disclosure. For example, the inventive principles and concepts of the present disclosure are not limited to the configurations of the screen shots shown in the figures or the GUIs. Persons of skill in the art will understand that the inventive processes and functions disclosed herein are not limited to any particular user interface or page configurations. These and other changes and modifications can be made to the systems and methods disclosed herein within the scope of the present disclosure and the inventive principles and concepts disclosed herein, as will be understood by those of skill in the art in view of the description provided herein.

1. A system assigning an insurance premium discount associated with vehicle safety features, the system comprising:
at least a first memory device that stores marketplace participant data comprising profiles, settings and preferences associated with at least a first dealer and with at least a first insurance company; and
at least a first processor configured to perform a process for operating an insurance premium discount marketplace, the process comprising:
receiving information relating to a user and to a vehicle for which the user desires to obtain vehicle insurance;
processing the received information to determine one or more safety features that the vehicle has and generating a vehicle IQ (VIQ) score based at least in part on said one or more safety features; and
processing the VIQ along with at least a portion of the stored marketplace participant data to determine whether at least one of said at least a first insurance company offers an insurance premium discount percentage for the vehicle, and if so, communicating at least a first insurance premium discount percentage quote to a computing device of the user.

2. The system of claim 1, wherein the marketplace participant data associated with said at least a first insurance company includes at least one range of VIQ scores for which said at least a first insurance company offers the insurance premium discount percentage, at least one safety feature for which said at least a first insurance company offers the insurance premium discount percentage, and at least one vehicle model for which said at least a first insurance company offers an insurance premium discount percentage.

3. The system of claim 2, wherein the process further comprises:
after communicating said at least a first insurance premium discount percentage quote to the computing device of the user, communicating a message to the computing device of the user prompting the user to communicate additional user information from the user's computing device to the system if the user desires to obtain a detailed insurance premium discount percentage quote from the system; and
if the user communicates the additional user information from the user's computing device to the system, processing the additional user information and communicating the detailed insurance premium discount percentage to the computing device of the user along with information informing the user of how to purchase an insurance policy for a price that includes the detailed insurance premium discount percentage quote.

4. The system of claim 2, wherein the process further comprises:
prior to receiving information relating to the user and to the vehicle for which the user desires to obtain vehicle insurance, detecting if the user has scanned in a code using the computing device of the user, and if so, communicating a page to the computing device that comprises data entry fields and instructions informing the user of the user information that is to be entered into the fields, and wherein the page also contains instructions instructing the user to upload to the system an image of a window sticker that is attached to a window of the vehicle, and wherein upon the user entering the user information and uploading the image of the window sticker, the processor performs the step of receiving information relating to the user and to the vehicle.

5. The system of claim 4, wherein the step of processing the received information to determine one or more safety features that the vehicle has and generating the VIQ score based at least in part on said one or more safety features comprises:
parsing the received information;
using the parsed information to obtain a list of safety features that the vehicle has from a database;
converting the safety features in the list into standardized safety features; and
generating the VIQ score based at least in part on the standardized safety features.

6. The system of claim 2, wherein said at least a first memory device comprises a plurality of memory devices, and said at least a first processor comprises a plurality of processors, each of the memory devices storing marketplace participant data comprising profiles, settings and preferences associated with a plurality of vehicle dealers and with a plurality of insurance companies, and wherein the marketplace participant data for each of the insurance companies includes at least one range of VIQ scores for which the respective insurance company offers the insurance premium discount percentage, at least one safety feature for which the respective insurance company offers the insurance premium discount percentage, and a plurality of vehicle models for which the respective insurance company offers an insurance premium discount percentage, and wherein the step of processing the VIQ along with at least a portion of the stored marketplace participant data comprises:
for each of the insurance companies, determining:
whether the VIQ falls within one of the ranges of VIQ scores associated with the respective insurance company;
if so, determining whether the respective insurance company offers an insurance premium discount percentage for the model of the vehicle;
if so, determining whether the vehicle has at least one safety feature that matches at least one safety feature for which the respective insurance company offers the insurance premium discount percentage; and
if so, communicating a respective first insurance premium discount percentage quote to the computing device of the user.

7. A method for assigning an insurance premium discount associated with vehicle safety features, the method comprising:
storing marketplace participant data comprising profiles, settings and preferences associated with at least a first dealer and with at least a first insurance company in at least a first memory device; and
with at least a first processor configured to perform a process for operating an insurance premium discount marketplace:
receiving information relating to a user and to a vehicle for which the user desires to obtain vehicle insurance;
processing the received information to determine one or more safety features that the vehicle has and generating a vehicle IQ (VIQ) score based at least in part on said one or more safety features; and
processing the VIQ along with at least a portion of the stored marketplace participant data to determine whether at least one of said at least a first insurance company offers an insurance premium discount percentage for the vehicle, and if so, communicating at least a first insurance premium discount percentage quote to a computing device of the user.

8. The method of claim 7, wherein the marketplace participant data associated with said at least a first insurance company includes at least one range of VIQ scores for which said at least a first insurance company offers the insurance premium discount percentage, at least one safety feature for which said at least a first insurance company offers the insurance premium discount percentage, and at least one vehicle model for which said at least a first insurance company offers an insurance premium discount percentage.

9. The method of claim 7, further comprising:
after communicating said at least a first insurance premium discount percentage quote to the computing device of the user, communicating a message to the computing device of the user prompting the user to communicate additional user information from the user's computing device to the system if the user desires to obtain a detailed insurance premium discount percentage quote from the system; and
if the user communicates the additional user information from the user's computing device to the system, processing the additional user information and communicating the detailed insurance premium discount percentage to the computing device of the user along with information informing the user of how to purchase an insurance policy for a price that reflects the detailed insurance premium discount percentage quote.

10. The method of claim 7, further comprising:
prior to receiving information relating to the user and to the vehicle for which the user desires to obtain vehicle insurance, detecting if the user has scanned in a code using the computing device of the user, and if so, communicating a page to the computing device that comprises data entry fields and instructions informing the user of the user information that is to be entered into the fields, and wherein the page also contains instructions instructing the user to upload to the system an image of a window sticker that is attached to a window of the vehicle, and wherein upon the user entering the user information and uploading the window sticker image, the processor performs the step of receiving information relating to the user and to the vehicle.

11. The method of claim 10, wherein processing the received information to determine one or more safety features that the vehicle has and generating the VIQ score based at least in part on said one or more safety features comprises:
parsing the received information;
using the parsed information to obtain a list of safety features that the vehicle has from a database;
converting the safety features in the list into standardized safety features; and
generating the VIQ score based at least in part on the standardized safety features.

12. The method of claim 7, wherein said at least a first memory device comprises a plurality of memory devices, and said at least a first processor comprises a plurality of processors, the storing step comprising storing each of the memory devices marketplace participant data comprising profiles, settings and preferences associated with a plurality of vehicle dealers and with a plurality of insurance companies, and wherein the marketplace participant data for each of the insurance companies includes at least one range of VIQ scores for which the respective insurance company offers the insurance premium discount percentage, at least one safety feature for which the respective insurance company offers the insurance premium discount percentage, and a plurality of vehicle models for which the respective insurance company offers an insurance premium discount percentage, and wherein processing the VIQ along with at least a portion of the stored marketplace participant data comprises:
for each of the insurance companies, determining:
whether the VIQ falls within one of the ranges of VIQ scores associated with the respective insurance company;
if so, determining whether the respective insurance company offers an insurance premium discount percentage for the model of the vehicle;
if so, determining whether the vehicle has at least one safety feature that matches at least one safety feature for which the respective insurance company offers the insurance premium discount percentage; and
if so, communicating a respective first insurance premium discount percentage quote to the computing device of the user.

13. A computer programs for assigning an insurance premium discount associated with vehicle safety features, the computer program comprising computer instructions for execution by at least a first processor of a system, the computer instructions being embedded in a non-transitory computer readable medium, the computer instructions comprising:
a first set of computer instructions for storing marketplace participant data in at least a first memory device, the marketplace participant data comprising profiles, settings and preferences associated with at least a first dealer and with at least a first insurance company in at least a first memory device;
a second set of computer instructions for receiving information from a computing device of a user relating to the user and to a vehicle for which the user desires to obtain vehicle insurance;
a third set of computer instructions for determining one or more safety features that the vehicle has and for generating a vehicle IQ (VIQ) score based at least in part on said one or more safety features; and
a fourth set of computer instructions for processing the VIQ along with at least a portion of the stored marketplace participant data to determine whether at least one of said at least a first insurance company offers an insurance premium discount percentage for the vehicle, and if so, communicating at least a first insurance premium discount percentage quote to a computing device of the user.

14. The computer program of claim 13, wherein the marketplace participant data associated with said at least a first insurance company includes at least one range of VIQ scores for which said at least a first insurance company offers the insurance premium discount percentage, at least one safety feature for which said at least a first insurance company offers the insurance premium discount percentage, and at least one vehicle model for which said at least a first insurance company offers an insurance premium discount percentage.

15. The computer program of claim 13, further comprising:
a fifth set of computer instructions, wherein after communicating said at least a first insurance premium discount percentage quote to the computing device of the user, the fifth set of computer instructions communicates a message to the computing device of the user prompting the user to communicate additional user information from the user's computing device to the processor if the user desires to obtain a detailed insurance premium discount percentage quote from the system; and
a sixth set of computer instructions, wherein if the user communicates the additional user information from the user's computing device to the processor, the sixth set of instructions processes the additional user information and communicates the detailed insurance premium discount percentage to the computing device of the user along with information informing the user of how to purchase an insurance policy for a price that reflects the detailed insurance premium discount percentage quote.

16. The computer program of claim 13, further comprising:
a fifth set of computer instructions, wherein prior to receiving information relating to the user and to the vehicle for which the user desires to obtain vehicle insurance, the fifth set of instructions detects if the user has scanned in a code using the computing device of the user, and if so, communicates a page to the computing device that comprises data entry fields and instructions informing the user of the user information that is to be entered into the fields, and wherein the page also contains instructions instructing the user to upload to the system an image of a window sticker that is attached to a window of the vehicle, and wherein upon the user entering the user information and uploading the image of the window sticker, the fifth set of computer instructions performs the step of receiving information relating to the user and to the vehicle.

17. The computer program of claim 16, wherein the third set of computer instructions processes the received information to determine one or more safety features that the vehicle has and to generate the VIQ score based at least in part on said one or more safety features comprises:
computer instructions for parsing the received information;
computer instructions for using the parsed information to obtain a list of safety features that the vehicle has from a database;
computer instructions for converting the safety features in the list into standardized safety features; and
computer instructions for generating the VIQ score based at least in part on the standardized safety features.

18. The computer program of claim 13, wherein said at least a first memory device comprises a plurality of memory devices, and said at least a first processor comprises a plurality of processors, and wherein the marketplace participant data comprises profiles, settings and preferences associated with a plurality of vehicle dealers and with a plurality of insurance companies, and wherein the marketplace participant data for each of the insurance companies includes at least one range of VIQ scores for which the respective insurance company offers the insurance premium discount percentage, at least one safety feature for which the respective insurance company offers the insurance premium discount percentage, and a plurality of vehicle models for which the respective insurance company offers an insurance premium discount percentage, and wherein the fourth set of computer instructions comprises:
instructions for determining, for each of the insurance companies:
whether the VIQ falls within one of the ranges of VIQ scores associated with the respective insurance company;
if so, whether the respective insurance company offers an insurance premium discount percentage for the model of the vehicle;
if so, whether the vehicle has at least one safety feature that matches at least one safety feature for which the respective insurance company offers the insurance premium discount percentage; and
if so, communicating a respective first insurance premium discount percentage quote to the computing device of the user.
